(19) United States
(12) Patent Application Publication
(10) Pub. No.: US 2012/0147513 A1
(43) Pub. Date: Jun. 14, 2012

(54) In-Line Static Electricity Removal Grounding Device

(76) Inventors: Carl P. Laird, White Oak, PA (US); Ralph W. Bardine, Hershey, PA (US)

(21) Appl. No.: 12/966,174

(22) Filed: Dec. 13, 2010

(51) Int. Cl. H05F 3/00

(52) U.S. Cl. 361/215

(57) ABSTRACT

A portable, in-line conveyor grounding system includes an electrically conductive metal pipe having a material flow section, with an inner diameter greater than that of an inlet and outlet, and a metallic grating disposed in the material flow section. An inlet attachment device and an outlet attachment device, as well as an electrically conductive wire with a grounding clamp, is provided. An electrically insulating wrapping is wrapped about the conductive wire and electrically conductive pipe, with a section of the wire having the grounding clamp exposed.

### FIELD OF THE INVENTION

The present invention relates to a device for reducing the electrostatic charge of a pneumatically transferred powdery material through a non-conductive conduit, such as a discharge hose from a transport vehicle to a storage or use facility.

### BACKGROUND OF THE INVENTION

Conveying of fine powdery material, such as hydrated lime, by pneumatic transfer, often leads to build-up or plugging of the conveyed material along the walls of the pneumatic piping and equipment in the form of a hard agglomerated mass in the nature of a cementitious agglomerate. The exact cause of such a build-up is not conclusively known, but one possible explanation for the cause of such a build-up is that such a build-up is a result of an electrostatic charge on the material being conveyed.

Devices currently used in the pneumatic conveying industry to reduce the static charge on conveyed material include the use of an electrical current between two plates, such as a Conveyastat In-Line Status Control System sold by SIMCO of Hatfield, Pa., U.S.A. Such a device when used with fine powdery material may finely coat ionic plates reducing the effectiveness of the device. Current pneumatic transfer users for hydrated lime, in order to use such a system, often try to ground the equipment as much as possible, along with treating the conveying air used for the pneumatic transfer, to reduce the tendency of build-up of agglomerated material inside the equipment.

It is an object of the present invention to provide a portable in-line device to reduce the potential for an electrostatic charge within fine material, such as hydrated lime, being pneumatically conveyed.

It is another object of the present invention to provide a device to reduce the electrostatic charge of a pneumatically conveyed material by contact with a stationary, highly conductive, well grounded metal, without significantly restricting the conveyed material path of the flow in process.

It is a further object of the present invention to provide a device that is a low-cost, portable, easy to build arrangement that will help to avoid build-up or plugging of fine conveyed powdery material in process piping or equipment of a pneumatic conveying system by reducing an electrostatic charge between conveyed material particles and process piping or equipment walls.

### SUMMARY OF THE INVENTION

A portable, in-line pneumatic conveyer grounding system is provided for use in conveying of fine powdery material. The system includes an electrically conductive metal pipe that has a material flow section and an inlet and outlet spaced from each other along a longitudinal axis of the metal pipe, with the material flow section having an inner diameter greater than the inner diameter of the inlet and outlet. Within the material flow section of the pipe there is a metallic grating disposed transverse to the longitudinal axis of the metal pipe. An inlet attachment device is provided at the inlet for attaching the metal pipe to a source of powdered material while an outlet attachment device is provided at the outlet for attaching the metal pipe to a collector for the powdered material. An electrically conductive wire is wrapped around the electrically conductive metal pipe, the wire having a grounding clamp thereon, and an electrically insulating wrapping is wrapped about the conductive wire and the electrically conductive metal pipe, with a section of the electrically conductive wire exposed and having the grounding clamp thereon.

The electrically conductive grating may be in the form of a screen or a plurality of spaced bars extending transverse the metallic pipe.

### BRIEF DESCRIPTION OF THE DRAWINGS

The present invention will become more readily apparent by reference to the following description of preferred embodiments taken in conjunction with the accompanying drawings wherein:

FIG. 1 is an elevational view showing a first embodiment of the pipe and grating of an in-line static electric removal grounding device of the present invention;

FIG. 2 is a cross-sectional view taken along lines II-II of FIG. 1;

FIG. 3 is a cross-sectional view taken along lines III-III of FIG. 1;

FIG. 4 is a cross-sectional view taken along lines IV-IV of FIG. 1;

FIG. 5 is a perspective view of the embodiment of FIG. 1 showing an electrically conducive wire wrapped about the electrically conductive pipe prior to wrapping with an electrically insulating wrapping;

FIG. 5A is a perspective view of the embodiment of FIG. 1 showing a ground lug electrically connected to the electrically conductive pipe;

FIG. 6 is a perspective view of the embodiment of FIG. 1 with an electrically insulating wrapping wrapped about the conductive wire and electrically conductive pipe with the exposed grounding clamp;

FIG. 6A is a perspective view of the embodiment of FIG. 1 having a ground lug electrically connected to the electrically conductive pipe and an electrically insulating wrapping wrapped around the pipe and lug;

FIG. 7 is an elevational view of a pipe and grating of a second embodiment of the present invention;

FIG. 8 is a cross-sectional view taken along lines VIII-VIII of FIG. 7;

FIG. 9 is a cross-sectional view taken along lines IX-IX of FIG. 7;

FIG. 10 is a view taken along lines X-X of FIG. 7;

FIG. 11 is a view showing the embodiment of the assembled portable, in-line pneumatic conveying grounding system illustrated in FIG. 7;

FIG. 12 is a further embodiment of the portable in-line pneumatic conveying system of the present invention showing use of an irregularly-shaped metal pipe with use of spaced bars as a grating;

FIG. 13 is a schematic elevational view of the embodiment shown in FIG. 12; and

FIG. 14 is a perspective view showing the assembled and wrapped system of the embodiment illustrated in FIG. 12.

### DETAILED DESCRIPTION

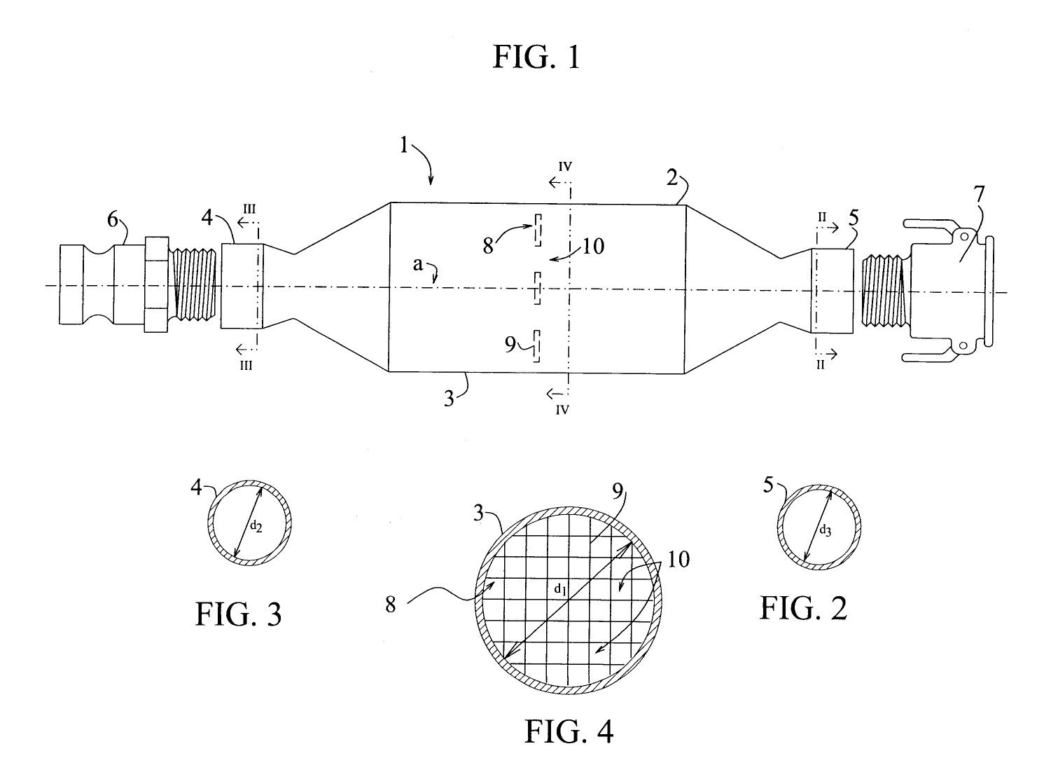

Referring now to FIG. 1, there is shown a preferred embodiment of the portable in-line pneumatic conveying grounding system of the present invention. The system includes an electrically conductive pipe (2), such as a metal pipe, that has a material flow section (3), an inlet (4), and an outlet (5), both of which may have internal threads. The material flow section (3) has an inner diameter d₁ which is larger than the inner diameter d₂ of the inlet (4) and the inner diameter d₃ of the outlet (5). The inlet (4) and the outlet (5) are spaced from each other along a longitudinal axis a of the metallic pipe (2). The pipe (2) is preferably composed of an affordable, electrically conductive metal, such as brass. Copper has been found to be disadvantageous for use as the pipe because it does not withstand the necessary pressures involved. The diameter of the inlets and outlet may be, e.g., about 3 inches to 8 inches in diameter depending on the application of the system, while the material flow section would preferably be about 1 to 2 inches in diameter larger than the diameter of the inlet and outlet. The inlet and outlet each have an attachment means, with an attachment means (6), such as a threaded coupling, threadedly attached to the inlet (4), which attachment means (6) is attached to a source of powdered material, while a further attachments means (7), such as a quick disconnect coupling, is threadedly attached to the outlet (5) for attachment to a collector, such as a discharge hose, storage bin, or reaction chamber.

A metallic electrically conductive grating (8), such as a metal screen (9), is disposed within the material flow section (3) of the pipe (2), the grating (8) being disposed transverse to the longitudinal axis a of the pipe (2). The screen (9) has openings (10) through which the powdered material flows from the inlet (4) to the outlet (5). The size of the screen openings and screen will vary depending upon the type and particle size of powdery material that is to flow through the screen in the metal pipe, with the screen having more than 60% of open area provided by the openings (10).

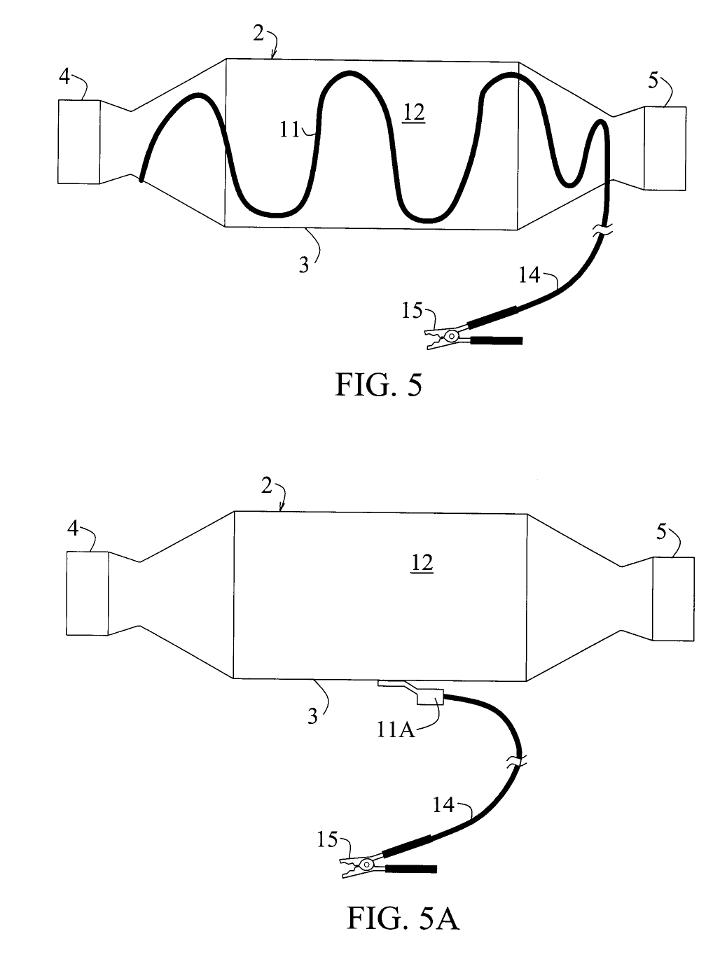

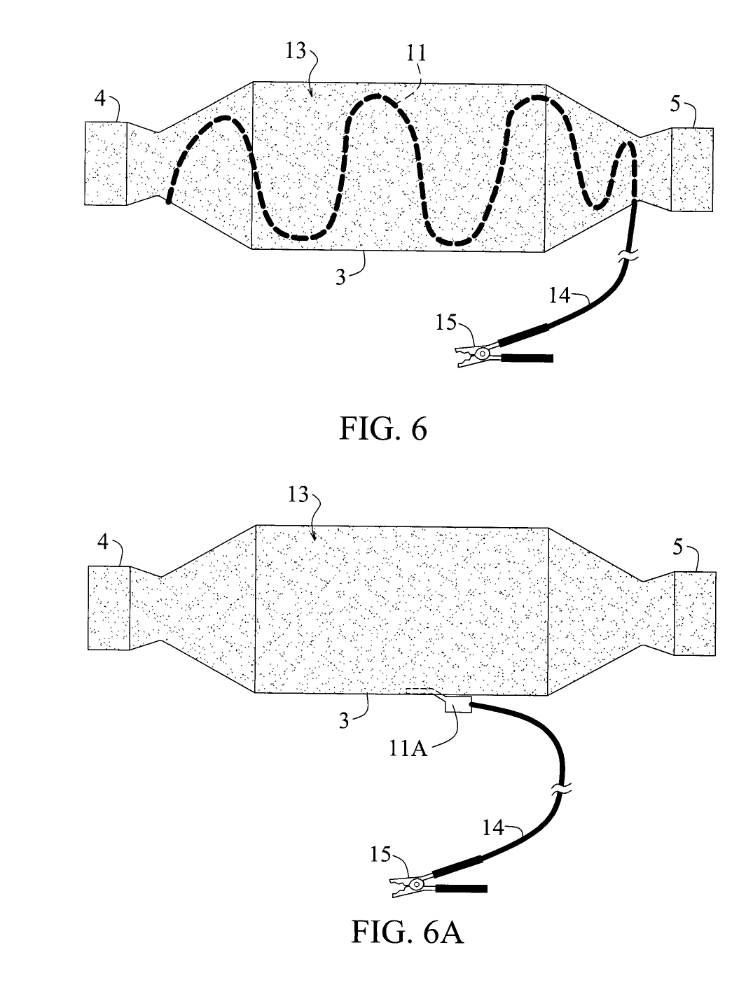

The electrically conductive pipe (2), as illustrated in FIG. 5, has an electrically conductive wire (11), such as a copper wire, wound about the outer surface (12) of the pipe, and an electrically insulating coating (13) is wrapped around the conductive wire (11) and the outer surface (12) of the metal pipe (2), as illustrated in FIG. 6. The electrically conductive wire (11) is provided with an exposed portion (14) that has attached thereon a grounding clamp (15).

As shown in FIGS. 5A and 6A, the electrically conductive wire shown in FIGS. 5 and 6 can be replaced with a ground lug 11A electrically connected to the electrically conductive pipe 2. The ground lug can be electrically connected by welding or soldering, for example.

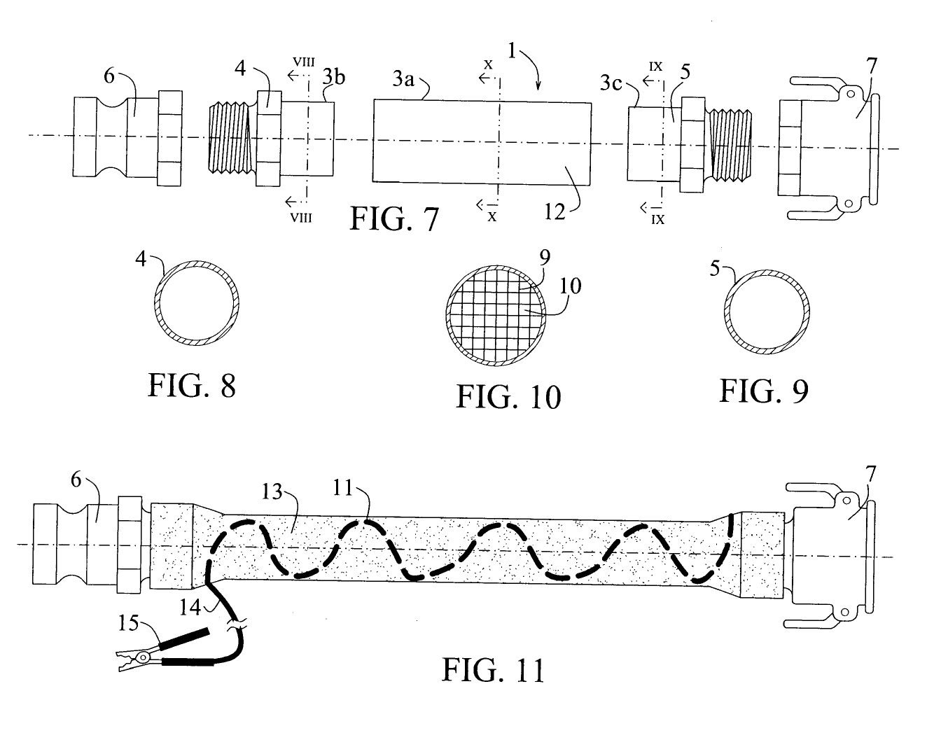

In the embodiment illustrated in FIG. 7-FIG. 11, the metallic pipe (2) is provided as three sections (3a), (3b) and (3c), in the form of two threaded adapters (3b) and (3c) and a material flow section (3a), which are secured together such as by soldering or brazing into a single unit. As with the first embodiment described, the material flow section (3a) has an interior diameter greater than the inlet (4) (section 3b) and the outlet (5) (section 3c).

As with the first embodiment described, the metal pipe (3a, 3b, 3c) has an electrically conductive wire wrapped there-around, and the pipe (3a, 3b, 3c) and wire (11) are coated with an electrically insulating cover (13), with an exposed portion (14) having a grounding clamp (15) attached. An attachment means (6), such as a threaded coupling is threadedly secured to the inlet (4), while a further attachment means (7), such as a quick disconnect coupling, is threadedly attached to the outlet (5).

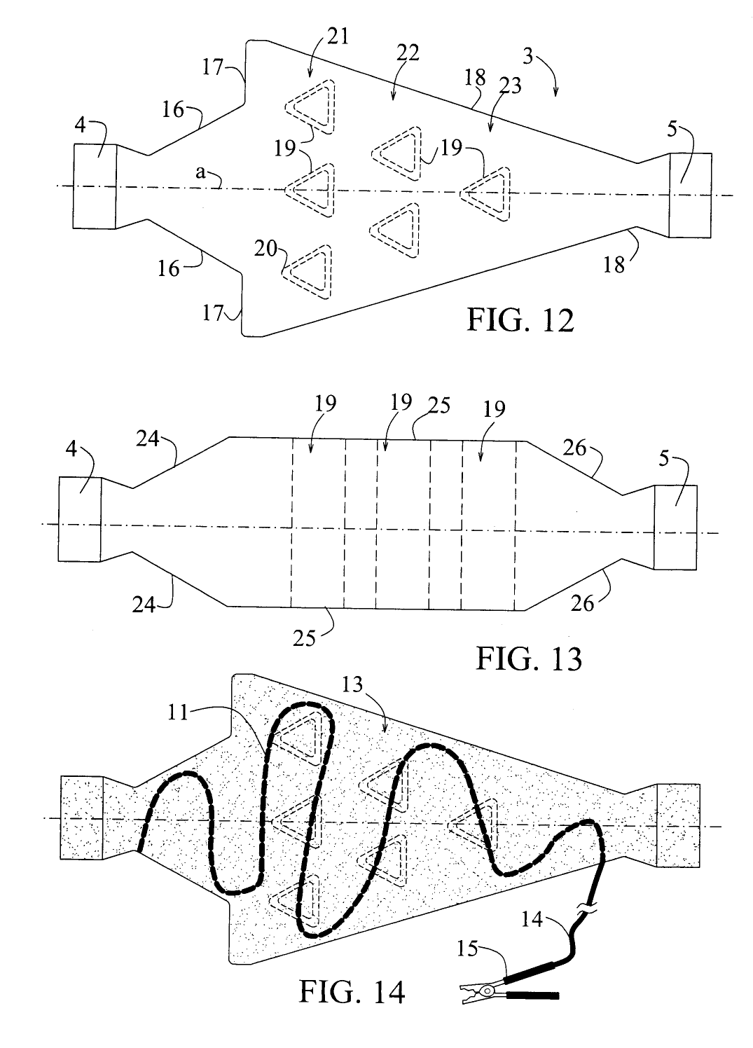

A further embodiment of the portable in-line pneumatic conveying grounding system is illustrated in FIGS. 12-14, where the grating is in the form of spaced bars situated in an enlarged section of the material flow section of an irregularly-shaped pipe. As illustrated, inlet (4) and outlet (5) are provided on a material flow section (3). The material flow section includes a diverging side wall portion, (16) connected to inlet (4), outwardly extending flanges (17) and a covering wall portion (18) connected to outlet (5). Spaced from the flanges (17) and within the converging side wall portion (18) is an electrically conductive grating which is composed of spaced bars (19) which are situate transverse the axis (a). The spaced bars are preferably in the shape of a triangle, with the apex (20) of each bar (19) facing in the direction of the inlet (4). A plurality of rows of each spaced bars (19) are preferably provided, as illustrated in FIG. 12, such as with three bars (19) in a first row (21), two bars (19) in a second row (22) and a single bar (19) in a third row (23), the number of bars in each row decreasing with converging of the wall portion (18). A top and a bottom wall diverging portion (24), top and bottom straight wall portion (25) and top and bottom convering wall portion (26) are also provided. As illustrated in FIG. 14, the metal pipe (3) has an electrically conductive wire (11) wrapped thereabout which is coated with an electrically insulating coating (13) and a portion (14) of the wire is exposed and has a grounding clamp (15) attached.

The operation of the portable in-line pneumatic conveying grounding system of the present invention is as follows. When a finely divided powdered material, such as hydrated lime, is to be transferred from a source, such as a transporter, to a silo or end use application, the inlet (4) is attached to the transport and the outlet (5) attached to the silo. The grounding clamp (15) is then attached to any grounding site. Powdered material is then pneumatically passed through the portable in-line pneumatic conveying ground system. As the powdered material passes through the system, any electrical charges that might arise are released through the wire (14) and clamp (15) to the ground, thus enabling free flow of the powdered material.

What is claimed is:

1. A portable in-line pneumatic conveying grounding system adapted for conveying of fine powdery material, comprising:
an electrically conductive pipe having a material flow section and an inlet and outlet spaced from each other along a longitudinal axis of the pipe, the material flow section of the pipe having an inner diameter larger than the inner diameter of said inlet and outlet;
a metallic electrically conductive grating disposed within the material flow section of the pipe transverse to said longitudinal axis;
first attachment means for attaching the inlet to a source of fine powdered material and second attachment means for attaching the outlet to a collector for the powdered material;
an electrically conductive means electrically connected to the electrically conductive pipe for conducting electricity away from the electrically conductive pipe and having a grounding clamp electrically connected thereto; and
an electrically insulating wrapping, wrapped about the electrically conductive means and electrically conductive pipe.

2. The portable in-line pneumatic conveying grounding system of claim 1, wherein the electrically conductive means is a wire wrapped about the electrically conductive pipe.

3. The portable in-line pneumatic conveying grounding system of claim 1, wherein the electrically conductive means is a grounding lug electrically connected to the electrically conductive pipe

4. The portable in-line pneumatic conveying grounding system of claim 1, wherein the grating is in the form of a screen.

5. The portable in-line pneumatic conveying grounding system of claim 1, wherein the screen is composed of an electrically conductive metal and has openings therethrough that comprise an open area through the screen of about sixty percent of the area of the screen.

6. The portable in-line pneumatic conveying grounding system of claim 1, wherein the metal pipe is composed of brass and the electrically insulating coating is composed of a natural or synthetic rubber.

7. The portable in-line pneumatic conveying grounding system of claim 2, wherein the electrically conductive wire is composed of copper.

8. The portable in-line pneumatic conveying grounding system of claim 1, wherein the grating is in the form of a spaced bars.

9. The portable in-line pneumatic conveying grounding system of claim 8, wherein the spaced bars are parallel with each other and formed as triangular bars, with an apex of each triangular bar facing the inlet of the electrically conductive pipe.

10. The portable in-line pneumatic conveying grounding system of claim 9, wherein a plurality of rows of spaced bars are provided along the longitudinal axis of the pipe.

11. The portable in-line pneumatic conveying grounding system of claim 10, wherein the metal flow section of the pipe includes diverging walls, outwardly extending flanges and conveying walls, from the inlet to the outlet.

12. A portable in-line pneumatic conveying grounding system adapted for conveying of fine powdery material, comprising:
an electrically conductive pipe having a material flow section and an inlet and outlet spaced from each other along a longitudinal axis of the pipe, the material flow section of the pipe having an inner diameter larger than the inner diameter of said inlet and outlet;
a metallic electrically conductive screen composed of an electrically conductive metal and having openings therethrough, that comprise an open area through the screen of about sixty percent of the area of the screen, disposed within the material flow section of the pipe transverse to said longitudinal axis;
first attachment means for attaching the inlet to a source of fine powdered material and second attachment means for attaching the outlet to a collector for the powdered material;
an electrically conductive means electrically connected to the electrically conductive pipe for conducting electricity away from the electrically conductive pipe and having a grounding clamp electrically connected thereto; and
an electrically insulating wrapping, wrapped about the electrically conductive means and electrically conductive pipe.

13. The portable in-line pneumatic conveying grounding system of claim 12, wherein the electrically conductive means is a wire wrapped about the electrically conductive pipe.

14. The portable in-line pneumatic conveying grounding system of claim 12, wherein the electrically conductive means is a grounding lug electrically connected to the electrically conductive pipe

15. The portable in-line pneumatic conveying grounding system of claim 12, wherein the metal pipe is composed of brass and the electrically insulating coating is composed of a natural or synthetic rubber.

16. A portable in-line pneumatic conveying grounding system adapted for conveying of fine powdery material, comprising:
an electrically conductive pipe having a material flow section and an inlet and outlet spaced from each other along a longitudinal axis of the pipe, the material flow section of the pipe having an inner diameter larger than the inner diameter of said inlet and outlet;
a metallic electrically conductive grating in the form of spaced bars disposed within the material flow section of the pipe transverse to said longitudinal axis;
first attachment means for attaching the inlet to a source of fine powdered material and second attachment means for attaching the outlet to a collector for the powdered material;
an electrically conductive means electrically connected to the electrically conductive pipe for conducting electricity away from the electrically conductive pipe and having a grounding clamp electrically connected thereto; and
an electrically insulating wrapping, wrapped about the electrically conductive means and electrically conductive pipe, the spaced bars being parallel with each other and formed as triangular bars, with an apex of each triangular bar facing the inlet of the electrically conductive pipe.

17. The portable in-line pneumatic conveying grounding system of claim 16, wherein the electrically conductive means is a wire wrapped about the electrically conductive pipe.

18. The portable in-line pneumatic conveying grounding system of claim 16, wherein the electrically conductive means is a grounding lug electrically connected to the electrically conductive pipe

19. The portable in-line pneumatic conveying grounding system of claim 12, wherein a plurality of rows of spaced bars are provided along the longitudinal axis of the pipe.

20. The portable in-line pneumatic conveying grounding system of claim 13, wherein the material flow section of a pipe includes diverging walls, outwardly extending flanges and converging walls, from the inlet to the outlet.
